(19) United States
(12) Patent Application Publication
(10) Pub. No.: US 2024/0422407 A1
(43) Pub. Date: Dec. 19, 2024

(54) VIDEO AUTHORING METHOD, APPARATUS, COMPUTER DEVICE AND STORAGE MEDIUM

(71) Applicant: Beijing Zitiao Network Technology Co., Ltd., Beijing (CN)

(72) Inventor: Xuhua LI, Beijing (CN)

(21) Appl. No.: 18/680,547

(22) Filed: May 31, 2024

(30) Foreign Application Priority Data
Jun. 15, 2023 (CN) 202310711124.X

(51) Int. Cl. H04N 21/854; H04N 21/234; H04N 21/431

(52) U.S. Cl. CPC H04N 21/854; H04N 21/23418; H04N 21/4318

(57) ABSTRACT

A video authoring method, an apparatus, a computer device and a storage medium are provided. The method includes: displaying a reading content of a target book; in response to a selection operation for at least one content segment in the target book, determining a target video material in a plurality of material dimensions that matches an attribute characteristic of the at least one content segment; generating an authored video associated with the target book based on the target video material and the at least one content segment which is selected.

### CROSS-REFERENCE TO RELATED APPLICATION

The present application claims the priority to the Chinese Patent Application No. 202310711124. X, filed on Jun. 15, 2023. the disclosure of which is hereby incorporated by reference in its entirety as part of the present application. All the aforementioned patent applications are hereby incorporated by reference in their entireties.

### TECHNICAL FIELD

The present disclosure relates to the field of computer technology, in particular to a video authoring method, an apparatus, a computer device and a storage medium.

### BACKGROUND

With the development of Internet technology, online reading is becoming more prevalent, and users can read any desired book using various novel reading applications. During the reading process, there may be video authoring needs for the user for portions of the content in the book to enable conversion from book content to visual content.

However, the conventional method of authoring video content using book content requires a user to manually create and upload materials and author videos using the manually uploaded materials, which consumes a lot of human resources and time, and results in relatively low efficiency for video authoring tasks.

### SUMMARY

Embodiments of the present disclosure provide at least a video authoring method, an apparatus, a computer device and a storage medium.

In a first aspect, an embodiment of the present disclosure provides a video authoring method, including: displaying a reading content of a target book; in response to a selection operation for at least one content segment in the target book, determining a target video material in a plurality of material dimensions that matches an attribute characteristic of the at least one content segment; generating an authored video associated with the target book based on the target video material and the at least one content segment which is selected.

In an alternative embodiment, determining the target video material in the plurality of material dimensions that matches the attribute characteristic of the at least one content segment in response to the selection operation for the at least one content segment in the target book includes: in response to the selection operation for the at least one content segment in the target book, displaying, for each of the material dimensions, a plurality of candidate video materials matching the attribute characteristic of the at least one content segment; determining the target video material selected by a user from each of the candidate video materials in the plurality of material dimensions.

In an alternative embodiment, determining the target video material in the plurality of material dimensions that matches the attribute characteristic of the at least one content segment in response to the selection operation for the at least one content segment in the target book includes: displaying a plurality of published videos that matches the attribute characteristic of the at least one content segment in response to the selection operation for the at least one content segment in the target book; determining a reference video selected by a user from the plurality of published videos and extracting the target video material of the reference video at the plurality of material dimensions.

In an alternative embodiment, after generating the authored video associated with the target book, the method further includes: integrating the authored video into a video collection corresponding to the target book. The video collection includes a plurality of authored videos associated with the target book, and the plurality of authored videos is associated with different content segments of the target book.

In an alternative embodiment, integrating the authored video into the video collection corresponding to the target book includes: determining a target video topic matching the authored video from video topics respectively corresponding to a plurality of video collections of the target book; integrating the authored video into the video collection corresponding to the target video topic.

In an alternative embodiment, generating the authored video associated with the target book based on the target video material and the at least one content segment which is selected includes: adding the content segment to a background picture material in the target video material to obtain a video frame picture; generating the authored video based on at least one selected from the group consisting of a background music material, a transition special effects material, and a dubbing material corresponding to the content segment in the target video material, and the video frame picture.

In an alternative embodiment, after generating the authored video associated with the target book, the method further includes: displaying a preview identification of the authored video at a preset location in the target book; or displaying a preview identification of the authored video in a recommended video display region associated with the target book; or displaying a preview identification of the authored video in a discussion group associated with the target book.

In an alternative embodiment, after generating the authored video associated with the target book, the method further includes: displaying a video editing page in response to an editing triggering operation for the authored video, the video editing page including a plurality of editing tools therein; acquiring a target authored video after editing the authored video based on the editing tool.

In a second aspect, an embodiment of the present disclosure further provides a video authoring apparatus, including: a first display module, configured to display a reading content of a target book; a determination module, configured to determine, in response to a selection operation for at least one content segment in the target book, a target video material in a plurality of material dimensions that matches an attribute characteristic of the at least one content segment; a generating module, configured to generate an authored video associated with the target book based on the target video material and the at least one content segment which is selected.

In a third aspect, an embodiment of the present disclosure also provides a computer device including: a processor, a memory and a bus, the memory storing machine-readable instructions executable by the processor, the processor in communication with the memory via the bus when the computer device is in operation, the machine-readable instructions when executed by the processor perform steps of the first aspect, or any of the optional implementation of the first aspect.

In a fourth aspect, an embodiment of the present disclosure also provides a computer readable storage medium, a computer program is stored on the computer readable storage medium, and when the computer program is executed by a processor, steps of the above-mentioned first aspect, or any of the optional implementation of the first aspect.

In order that the above objects, features and advantages of the present disclosure will be more readily apparent, the following detailed description of the preferred embodiments will be given with reference to the accompanying drawings.

### BRIEF DESCRIPTION OF DRAWINGS

In order to more clearly illustrate the technical solutions of the embodiments of the present disclosure, the accompanying drawings required for use in the embodiments, which are incorporated in and constitute a part of the specification, illustrate embodiments consistent with the present disclosure and, together with the description, serve to explain the technical solutions of the present disclosure, will be briefly described below. It is to be understood that the following drawings illustrate only certain embodiments of the present disclosure and are therefore not to be considered limiting in scope, and that other related drawings may be derived therefrom by one of ordinary skill in the art without inventive step.

FIG. 1 shows a flowchart of a method of video authoring according to an embodiment of the present disclosure;

FIG. 2 shows a process for displaying candidate video materials according to an embodiment of the present disclosure;

FIG. 3 illustrates a process for displaying published videos according to an embodiment of the present disclosure;

FIG. 4 shows an illustrative diagram of video collections according to an embodiment of the present disclosure;

FIG. 5 shows an architectural schematic diagram of a video authoring apparatus according to an embodiment of the present disclosure;

FIG. 6 shows a schematic diagram of a computer device according to an embodiment of the present disclosure.

### DETAILED DESCRIPTION

To make the objects, technical solutions and advantages of the embodiments of the present disclosure clearer, the technical solutions in the embodiments of the present disclosure will be clearly and completely described below in conjunction with the accompanying drawings in the embodiments of the present disclosure, it is obvious that the described embodiments are only a part of the embodiments of the present disclosure, rather than all of the embodiments. The components of the embodiments of the present disclosure as generally described and illustrated in the figures herein could be arranged and designed in a wide variety of different configurations. Thus, the following detailed description of the embodiments of the disclosure, as provided in the figures, is not intended to limit the scope of the disclosure, as claimed, but is merely representative of selected embodiments of the disclosure. Based on the embodiments of the present disclosure, all other embodiments obtained by those skilled in the art without making creative labor belong to the scope of protection of the present disclosure.

Through research, it has been found that in novel reading type applications, a user is required to actively upload video content generation materials such as video cover information, video background music information, and the like in the case of authoring a corresponding video for a content in a book. The user may then generate corresponding video content based on the uploaded material as well as the book content. This manner of video generation requires the user to gather and upload relevant materials himself, which consumes more time and human resources, affects the efficiency of video generation, and also affects the aggressiveness of the user to author the video.

Based on this, embodiments of the present disclosure provide a video authoring method, apparatus, computer device, and storage medium that saves human resources and material acquisition time by actively providing target video materials under a plurality of material dimensions after responding to a selection operation for at least one content segment, without requiring a user to manually create and upload video material. The creation of an authored video based on target video materials and content segments reduces the difficulty of video authoring, improves the speed of video authoring, and allows for quick and convenient conversion of book content to video content. Also, because the video authoring method provided by the embodiments of the present disclosure can help users to realize the authoring of video contents quickly and easily, compared to the manner in which human uploaded materials are required to generate the video, the user's enthusiasm of video authoring can be improved, the number of video contents corresponding to the target book can be improved, thereby facilitating other users to learn the book with a large number of video contents, and increasing the readability and interactivity of the book.

The deficiencies and proposed solutions to the above solutions are all the results of the inventor's practice and careful study, and therefore, the discovery process of the above problems and the solution proposed by the present disclosure to the above problems hereinafter should be contributions made by the inventor to the present disclosure during the course of the present disclosure.

It should be noted that like numerals and letters represent like items in the following figures, and therefore, once an item is defined in one figure, it need not be further defined and explained in the following figures.

It can be understood that before using the technical solution disclosed by the embodiments of the present disclosure, the user should be informed of the type, the use range, the use scenario, and the like of the personal information to which the present disclosure relates and obtain the authorization of the user in an appropriate manner according to the relevant laws and regulations.

To facilitate understanding of the present embodiments, first, a video authoring method disclosed by the embodiments of the present disclosure will be described in detail, and the execution body of the video authoring method provided by the embodiments of the present disclosure is generally a computer device with certain computing power.

The following explains the video authoring method provided by the embodiments of the present disclosure taking the execution body as the terminal apparatus as an example.

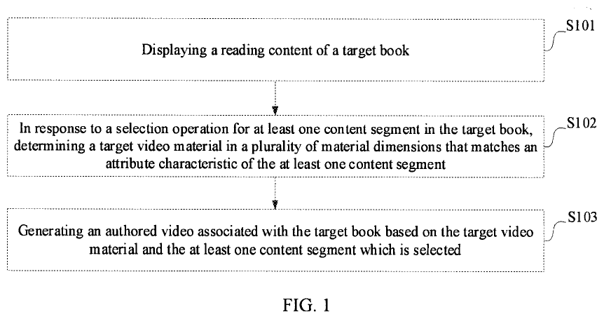

As shown in FIG. 1, a flow chart of a video authoring method provided by an embodiment of the present disclosure may include the following steps:

S101: Displaying a reading content of a target book.

In some examples, the target book may be any book capable of being read online. For example, the target book may be a book provided by any novel reading application.

In some examples, the reading content is a book content in the target book. For example, the reading content may be a content in any page of the target book, a content in any chapter, or the like. The reading content may be presented in any reading device capable of being used for book reading. For example, the reading device may be a cell phone, a computer, a novel-specific reading device, or the like.

For example, when the user reads the target book using the novel reading application installed in the reading device, the corresponding currently read reading content of the target book may be displayed in the reading device.

S102: In response to a selection operation for at least one content segment in the target book, determining a target video material in a plurality of material dimensions that matches an attribute characteristic of the at least one content segment.

In some examples, the attribute characteristic may be used to characterize a content style type, a content genre, a content importance, a content complexity, etc. information to which the content segment corresponds. For example, the content style type may include a funny humor type, a sad type, a harmonic type, an emotional type, an incentive type, and the like. For example, the content genre may include an entertainment genre, a sports genre, a romance genre, a war genre, a documentary genre, a social genre, a natural genre, a psychological genre, and the like.

In some examples, a material dimension is used to characterize the type of material, e.g., a video background picture dimension, a video audio dimension, a video cover dimension, a video special effect dimension, a text dubbing dimension, and the like.

In some examples, the content segment may be content in any page currently being presented by the target book, content in any chapter, content under any scene, content in any story segment, etc., which may include text content and/or picture content. For example, one content segment may have at least one attribute characteristic and may correspond to at least one target video material in at least one material dimension.

In the specific implementation, after the user selects at least one content segment in the target book, the attribute characteristics of the content segment may be determined in response to the selection operation of the user, and the target video material in a plurality of material dimensions matching the attribute characteristics may be determined from a plurality of preset video materials. For example, in the case where the attribute characteristic includes the romance genre, the funny humor type, the important complex content type, initial video materials (e.g., funny cover associated with emotions, funny background music associated with emotions, etc.) can be obtained for each material dimension that matches the romance genre and the funny humor type. A target video material that matches the important complex content type may then be selected from the initial video materials. For example, in the case where the initial video materials include a simple initial material and a complex initial material, the complex initial material may be used as the final determined target video material.

In some examples, in the case where the number of content segments is multiple, in addition to determining the target video material to which each content segment corresponds, fusion attribute characteristics corresponding to the plurality of content segments may also be determined from the attribute characteristics corresponding to the plurality of content segments, respectively. Thereafter, according to the fusion attribute characteristics, target video materials that respectively match the fusion attribute characteristics under the plurality of material dimensions may be determined, which may be used to generate a fusion video fused with a plurality of content segments.

In one embodiment, for the above S102, the following steps may be implemented:

S102-1: In response to the selection operation for the at least one content segment in the target book, displaying, for each of the material dimensions, a plurality of candidate video materials matching the attribute characteristic of the at least one content segment.

In some examples, the candidate video material may be a video material among a plurality of preset video materials that matches the attribute characteristics of the content segment at each material dimension. A plurality of target video materials in each material dimension may be composed into a material collection in that material dimension.

In the specific implementation, in response to the selection operation for the at least one content segment, for each material dimension, a plurality of candidate video materials may be selected that match the attribute characteristics of at least some of the at least one content segment from among a plurality of preset video materials in the material dimension. For example, the plurality of candidate video materials may be preset video materials that are ranked according to the degree of match with the attribute characteristic and that are greater than a preset ranking. In this way, multiple target video materials are available at each material dimension. Further, a plurality of target video materials corresponding to each material dimension may be displayed, i.e., the material collection in each material dimension may be displayed.

For example, in response to selecting a plurality of content segments, for each material dimension, a plurality of candidate video materials may be determined and displayed based on the fusion attribute characteristics corresponding to the plurality of content segments.

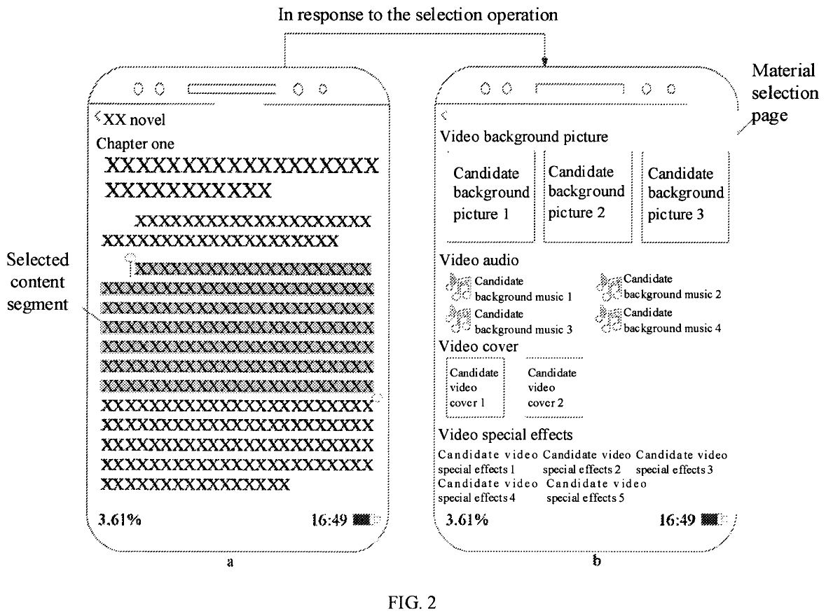

FIG. 2 illustrates a process for displaying candidate video materials according to an embodiment of the present disclosure. A letter a in FIG. 2 is a schematic view of the content segment being selected, and the content shown in a is the reading content of the currently displayed target book, which includes the selected content segment. After the user selects the content segment, a material selection page as shown in b of FIG. 2 may be displayed in response to the selection operation, in which a plurality of candidate video materials is displayed that match respective material dimensions. In b of FIG. 2, the material dimensions include a video background picture dimension, a video audio dimension, a video cover dimension and a video special effects dimension, the video audio dimension includes candidate background pictures 1˜3 that match the attribute characteristics of the content segment, the video audio dimension includes candidate background music 1˜4 that match the attribute characteristics of the content segment, the video cover dimension includes candidate video covers 1 and 2 that match the attribute characteristics of the content segment, and the video special effects dimension includes candidate video special effects 1˜5 that match the attribute characteristics of the content segment.

S102-2: Determining the target video material selected by a user from each of the candidate video materials in the plurality of material dimensions.

In the specific implementation, after displaying the plurality of candidate video materials in each material dimension, the candidate video material selected by the user may be taken as the target video material in response to the selection operation (e.g., a click operation, a double click operation, a box selection operation, etc.) of the user with respect to the displayed candidate video material. For example, for the video collection in each material dimension, the user may select target video material in a corresponding material dimension from the video collection. For example, a picture material/video material, an audio material, a special effects material, a dubbing material, etc. may be selected to match the content segment. For example, in the case of the picture material, the picture material may indicate the text content of the book in the content segment, may be information such as viewer feedback, the picture material may be applied directly as video material, or may be applied as video material after converting the text content of the book in the picture material into speech.

For example, each target video material may be obtained in response to the selection operation of the user for the candidate video material in each material dimension illustrated in b of FIG. 2.

Thus, by displaying the plurality of candidate video materials in each material dimension for selection by the user, it is possible to support flexible selection of video materials by the user, to select target video materials of interest, and to author a video using the target video materials selected by the user, so that the authored video is more consistent with the expectations of the user, thereby improving the plausibility and accuracy of the authored video.

In another embodiment, the above S102 may be further implemented as follows:

Step 1: Displaying a plurality of published videos that matches the attribute characteristic of the at least one content segment in response to the selection operation for the at least one content segment in the target book.

In some examples, the published video is filtered out of published authored videos that the user authorizes to obtain, which matches the attribute characteristics. The published authored video may be a video previously authored by any user based on the book content of any target book, or may be a video authored by the user who currently selected the content segment based on the book content of any target book.

In the specific implementation, a plurality of published videos matching the attribute characteristics of the at least one content segment may be obtained in response to the selection operation by a user for the at least one content segment, and then the plurality of published videos may be displayed. For example, the published videos may be determined based on the degree of match between the attribute characteristics of the at least one content segment and the video material in each published authored video, and/or the degree of match between the attribute characteristics of the at least one content segment and each published authored video.

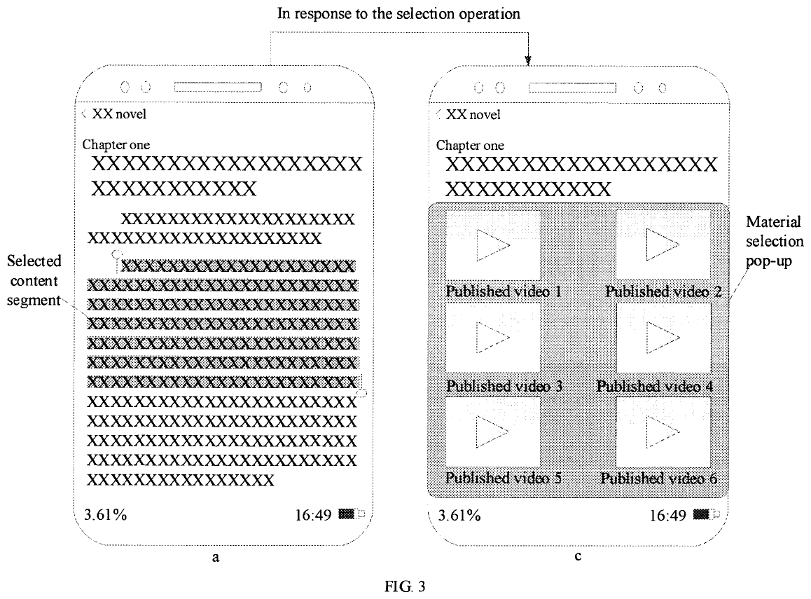

FIG. 3 illustrates a process for displaying published videos according to an embodiment of the present disclosure. The letter a in FIG. 3 is a schematic view of a content segment being selected. After the user selects the content segment, a material selection pop-up as shown in c of FIG. 3 may be displayed in response to the selection operation. The material selection pop-up may be overlaid on the reading content, and a plurality of published videos may be displayed in the material selection pop-up. In c of FIG. 3, published videos 1˜6 are shown that match the attribute characteristics of at least one content segment.

Step 2: Determining a reference video selected by a user from the plurality of published videos and extracting the target video material of the reference video at the plurality of material dimensions.

For example, the reference video selected by the user may be obtained in response to the selection operation by the user for at least one of the plurality of published videos displayed in c. Thereafter, for the reference video, target video materials respectively corresponding to the plurality of material dimensions may be extracted from the reference video according to the video information in the reference video. Understandably, at a certain material dimension, the extracted target video material may be empty.

For example, the target video material extracted from the reference video may include, but is not limited to, the background picture material, the background music material, the transition special effects material, the text dubbing material, and the video cover material.

Thus, by displaying the published video for selection by the user, the user can be assisted in knowing in advance the various video effects of the authored video that may be generated based on the video effects of the displayed published video, and can then select a reference video of interest. Finally, using the target video material extracted from the reference video for video authoring can make the authored video more consistent with the expectations of the user, improving the plausibility and accuracy of the authored video.

Alternatively, after the target video material is determined, the user may be supported to autonomously produce and upload the video material, and then the target video material ultimately to be used may be determined based on at least one of the video materials uploaded by the user, the candidate video material, and the video material extracted from the reference video.

Thus, in the case of supporting the manual uploading of the target video material, the variety of ways of obtaining the video authoring material can be improved, and the selection of the target video material and the creation of the video can be performed in a variety of ways, and the plausibility and accuracy of the authored video can be further improved.

S103: Generating an authored video associated with the target book based on the target video material and the at least one content segment which is selected.

In some examples, the authored video is an authored video related to the selected content segment, which may be associated with the target book as one video corresponding to the target book.

In the specific implementation, respective target video materials may first be stitched together to obtain an initial video; then, a speech material corresponding to the text content in the content segment may be generated; the content segment and the speech material may finally be added to the initial video to get the authored video.

In one embodiment, the target video material may include the background picture material in the video background picture dimension, the background music material in the video audio dimension, the transition special effects material in the video special effects dimension, and the dubbing material in the text dubbing dimension, for example, the dubbing material may be generated from the text content in the content segment and/or a derivative text content (e.g., viewer feedback, text annotations, etc.) corresponding to the content segment. The following steps may be followed for the above S103:

S103-1: Adding the content segment to a background picture material in the target video material to obtain a video frame picture.

In some examples, the background picture material may be specifically a background picture template, and after obtaining the background picture material, a content segment may be added to the background picture material, thereby obtaining a video frame picture with a specific book content.

S103-2: Generating the authored video based on at least one selected from the group consisting of a background music material, a transition special effects material, and a dubbing material corresponding to the content segment in the target video material, and the video frame picture.

For example, music in the background music material may be used as background music, and the text dubbing in the dubbing material corresponding to the content segment, the transition special effects indicated by the transition special effects material, and the video frame picture may be combined, thereby obtaining the authored video corresponding to the content segment. For example, the background music of the authored video may be less vocal than the text dubbing, and the background music, the text dubbing may be played, and the video frame picture and transition special effects may be displayed during playback of the authored video.

Alternatively, with respect to the specific manner of generating the authored video using the background picture material, the background music material, the transition special effects material, and the dubbing material corresponding to the content segment, reference may also be made to the existing generation method, and the embodiment of the present disclosure is not particularly limited.

In this way, by proactively providing target video material under the plurality of material dimensions after responding to the selection operation for at least one content segment, the user is not required to manually create and upload the video material, saving human resources and material acquisition time. The creation of the authored video based on the target video material and the content segment reduces the difficulty and improves the speed of video authoring, and allows for quick and convenient conversion of the book content to the video content. Also, because the video authoring method provided by the embodiments of the present disclosure can help users to realize the authoring of video contents quickly and easily, compared to the manner in which human uploaded materials are required to generate the video, the user's enthusiasm of video authoring can be improved, the number of video contents corresponding to the target book can be improved, thereby facilitating other users to learn the book with a large number of video contents, and increasing the readability and interactivity of the book.

In one embodiment, after generating the authored video associated with the target book, the authored video may also be added to the video collection corresponding to the target book. For example, the video collection includes a plurality of authored videos associated with the target book, the plurality of authored videos is associated with different content segments of the target book.

In some examples, a video collection corresponding to one target book may include a plurality of authored videos authored by the same user or a plurality of authored videos authored by different users. For example, different authored videos in the video collection may be authored with different content segments in the target book.

For example, the video collection for the target book may include, in the target book, the authored video 1 corresponding to the content segment 1, the authored video 2 corresponding to the content segment 2, the authored video 3 corresponding to the content segment 3, and the authored video 5 corresponding to the content segment 5, and the authored video 6 corresponding to the content segment 6 may be added to the video collection after the current generation of the authored video 6 corresponding to the content segment 6.

In one embodiment, one book may also correspond to multiple video collections, and different video collections may correspond to different video topics, and different video topics may correspond to different content segments in the book. For example, different video topics may correspond to contents of different notable scenes in a book, different video topics correspond to book contents in different moods in a book, different video topics correspond to book contents under different episodes in a book, and so on. The division of the subject matter of the video may be determined according to the information of the content segment under any preset dimension or the information of the authored video under any preset dimension.

In the case where the target book corresponds to the video collection under a plurality of different video topics, the above step of integrating the authored video into the video collection corresponding to the target book may be implemented as follows: determining a target video topic matching the authored video from video topics respectively corresponding to a plurality of video collections of the target book; integrating the authored video into the video collection corresponding to the target video topic.

In the specific implementation, the video topics to which the plurality of video collections associated with the target book respectively correspond may be determined; the video topic of the authored video may then be determined from the video content of the most recent authored video currently authored and/or the content segment corresponding to the authored video; then, the target video topic having the highest matching degree with the video topic of the authored video may be determined from among the video topics respectively corresponding to the plurality of video collections; finally, the authored video can be added to the video collection corresponding to the target video topic.

For example, the video collections corresponding to the target book include video collections 1˜4, a video topic corresponding to a video collection 1 is a notable scene 1, a video topic corresponding to a video collection 2 is a notable scene 2, a video topic corresponding to a video collection 3 is a plot A, and a video topic corresponding to a video collection 4 is a character A, then after generating the authored video 5, the video topic for the authored video 5 can be determined first (e.g., the video topic is related to the notable scene 2). Then, the target video topic of the video topics corresponding to the video collections 1˜4, which matches the video topic of the authored video 5 with the highest degree, may be determined, e.g., the notable scene 2, and the authored video 5 may be added to the video collection 2. Alternatively, after determining the video topics respectively corresponding to the plurality of video collections associated with the target book, the matching degree of the authored video with the respective video topics can be determined according to the video content of the authored video, the video topic with the highest matching degree is taken as the target video topic, and the authored video is added to the video collection corresponding to the target video topic.

Alternatively, assuming that the matching degree between the video topics respectively corresponding to the plurality of video collections and the video topics of the authored video is lower than a preset value, a video collection associated with the target book may be newly created, and the authored video may be added to the video collection. For example, the video topic of the video collection can be the video topic of the authored video.

Alternatively, in the case where the number of video collections corresponding to the target book is plural, the respective video collections and the video topics of each video collection may be displayed in the form of pop-up windows after the creation of the authored video. Thereafter, in response to the selection operation by the user for any one of the video collections displayed, the video topic corresponding to the video collection may be taken as the target video topic, and the authored video may be added to the video collection.

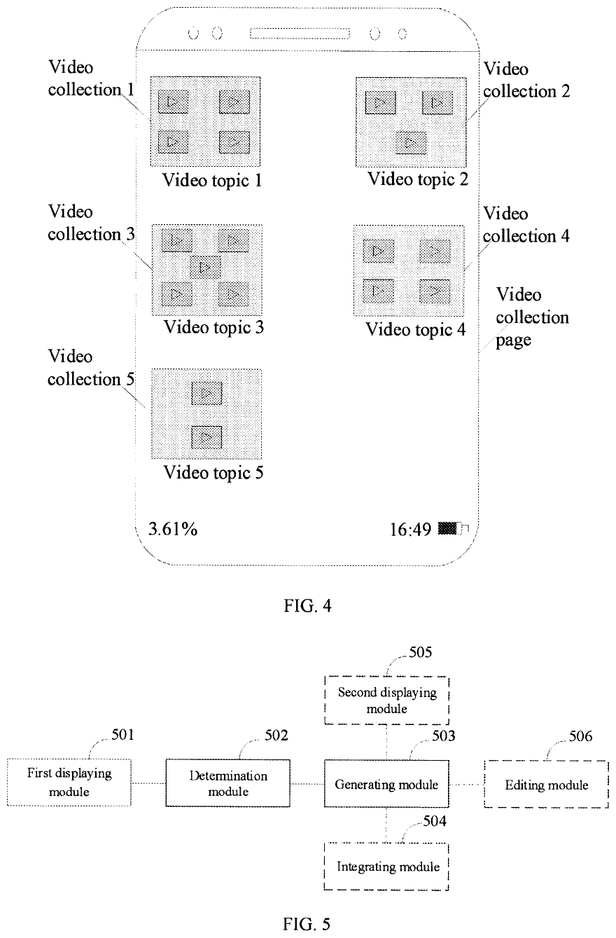

FIG. 4 is a schematic illustration of video collections according to an embodiment of the present disclosure. After generating the authored video, a video collection page can be presented as shown in FIG. 4, in which there are five video collections (i.e., video collections 1˜5) presented, each video collection corresponds to one video topic (i.e., video topics 1˜5). Thereafter, the authored video may be added to any of the video collections selected in response to the selection operation by the user for that video collection.

In one embodiment, after generating the authored video associated with the target book, the authored video may also be displayed to facilitate more convenient acquisition and viewing of the video by the user. In the specific implementation, the authored video may be displayed in at least one of three ways as follows:

Mode 1: Displaying a preview identification of the authored video at a preset location in the target book.

For example, the preset position may be set empirically, and the embodiments of the present disclosure are not particularly limited. For example, the preset position may be determined according to a position of the content segment corresponding to the authored video, for example, the preset position may be an end position of the content segment, a page bottom end of a book page to which the content segment belongs, a chapter end position of a book chapter to which the content segment belongs, a book end of the target book to which the content segment belongs, or the like. For example, the preview identification is used to preview the authored video or to play the authored video after being triggered.

For example, after the creation of the authored video, the preview identification for previewing or playing the authored video may be displayed at the page bottom end of the book page to which the content segment corresponding to the authored video belongs.

Optionally, in the case where the target book corresponds to the video collection, after the authored video is added to the video collection corresponding to the target video topic, a collection preview identification corresponding to the video collection may also be displayed at the preset position in the target book. For example, the video preview identification is used to display respective authored videos in the video collection upon triggering. For example, the video preview identification corresponding to the video collection may be displayed at the book end of the target book.

Mode 2: Displaying a preview identification of the authored video in a recommended video display region associated with the target book.

For example, the recommended video display region is used to display respective recommended videos associated with the target book. For example, the recommended video display region may be a preset recommended video display region corresponding to the novel reading application that may be used to display recommended videos corresponding to any of the books provided by the novel reading application.

In the specific implementation, after the authored video is generated, the authored video may be treated as a recommended video associated with the target book, and then a preview identification of the authored video may be displayed in the recommended video display region associated with the target book. Alternatively, the authored video may be displayed directly in the recommended video display region associated with the target book.

Mode 3: Displaying a preview identification of the authored video in a discussion group associated with the target book.

For example, each book may be associated with one discussion group that may include various user-initiated topic discussion information for the book, and respective users may discuss and learn about the book contents based on the topic discussion information in the discussion group.

In the specific implementation, after the authored video is generated, the preview identification of the authored video may be displayed in the discussion group associated with the target book according to the time of generation of the authored video and/or the amount of browsing of the target book. Alternatively, the authored video may be displayed directly in the discussion group associated with the target book.

As such, the display of the authored video is made based on at least one of the three modes described above, it is possible to increase the convenience of the user to acquire the authored video, and in turn to improve the exposure of the authored video.

In one embodiment, in order to further improve the plausibility and accuracy of the generated authored video, after generating the authored video associated with the target book, further edits may be made to the authored video to get the authored video that more closely conforms to the user's expectations. In the specific implementation, the authored video may be edited according to the following steps:

S1: Displaying a video editing page in response to an editing triggering operation for the authored video; the video editing page including a plurality of editing tools therein.

For example, different editing tools have different editing functions, the video editing page may be displayed with the authored video, the respective frames of video frame images corresponding to the authored video, the various editing tools, and the like.

For example, the video editing page may be displayed in response to triggering the video editing function.

S2: Acquiring a target authored video after editing the authored video based on the editing tool.

In the specific implementation, after the video editing page, the user may utilize the editing tools of the video editing page to make secondary edits to the authored video, such as adding audio to the authored video, cropping the length of the video, adding special effects to the video, editing the text of the video, and the like. In this way, the target authored video after the editing of the authored video based on the editing tool is obtained after the editing is completed by the user.

As such, by secondary editing of the authored video, the final generated target authored video can be made more consistent with the user's expectations, improving the plausibility of the target authored video.

It will be appreciated by those skilled in the art that in the above described method of the specific implementation, the order in which the steps are written does not imply a strict order of execution and constitutes any limitation on the implementation of the process, and that the specific order of execution of the steps should be determined by their functionality and possibly the underlying logic.

Based on the same inventive concept, the video authoring apparatus corresponding to the video authoring method is further provided in the embodiment of the present disclosure, because the principle of solving the problem by the apparatus in the embodiment of the present disclosure is similar to the above video authoring method of the embodiment of the present disclosure, the implementation of the apparatus can be referred to the implementation of the method, and the repetitions are not repeated.

FIG. 5 is an architectural schematic diagram of a video authoring apparatus according to an embodiment of the present disclosure, the apparatus includes: a first displaying module 501, configured to display a reading content of a target book; a determination module 502, configured to determine, in response to a selection operation for at least one content segment in the target book, a target video material in a plurality of material dimensions that matches an attribute characteristic of the at least one content segment; a generating module 503, configured to generate an authored video associated with the target book based on the target video material and the at least one content segment which is selected.

In one possible implementation, the determining module 502, when determine, in response to the selection operation for the at least one content segment in the target book, the target video material in the plurality of material dimensions that matches an attribute characteristic of the at least one content segment, is configured to: in response to the selection operation for the at least one content segment in the target book, display, for each of the material dimensions, a plurality of candidate video materials that match the attribute characteristic of the at least one content segment; determine the target video material selected by a user from each of the candidate video materials in the plurality of material dimensions.

In one possible implementation, the determining module 502, when determine, in response to the selection operation for the at least one content segment in the target book, the target video material in the plurality of material dimensions that matches an attribute characteristic of the at least one content segment, is configured to: display a plurality of published videos that matches the attribute characteristic of the at least one content segment in response to the selection operation for the at least one content segment in the target book; determine a reference video selected by a user from the plurality of published videos and extracting the target video material of the reference video at the plurality of material dimensions.

In one possible implementation, the apparatus further includes an integrating module 504 configured to integrate the authored video into a video collection corresponding to the target book after generating the authored video associated with the target book. The video collection includes a plurality of authored videos associated with the target book, the plurality of authored videos being associated with different content segments of the target book.

In one possible implementation, the integrating module 504, when integrate the authored video into the video collection corresponding to the target book, is configured to: determine a target video topic matching the authored video from video topics respectively corresponding to a plurality of video collections of the target book; integrate the authored video into the video collection corresponding to the target video topic.

In one possible implementation, the generating module 503, when generate the authored video associated with the target book based on the target video material and the at least one content segment which is selected, is configured to: add the content segment to a background picture material in the target video material to obtain a video frame picture; generate the authored video based on at least one selected from the group consisting of a background music material, a transition special effects material, and a dubbing material corresponding to the content segment in the target video material, and the video frame picture.

In one possible implementation, the apparatus further comprises a second displaying module 505, after generating the authored video associated with the target book, configured to: display a preview identification of the authored video at a preset location in the target book; or display a preview identification of the authored video in a recommended video display region associated with the target book; or display a preview identification of the authored video in a discussion group associated with the target book.

In one possible implementation, the apparatus further includes an editing module 506, after generating the authored video associated with the target book, configured to display a video editing page in response to an editing triggering operation for the authored video, the video editing page including a plurality of editing tools therein; acquire a target authored video after editing the authored video based on the editing tool.

The description of the process flow of the respective modules in the apparatus, and the interaction flow between the respective modules can refer to the related description in the above method embodiments, which will not be detailed here.

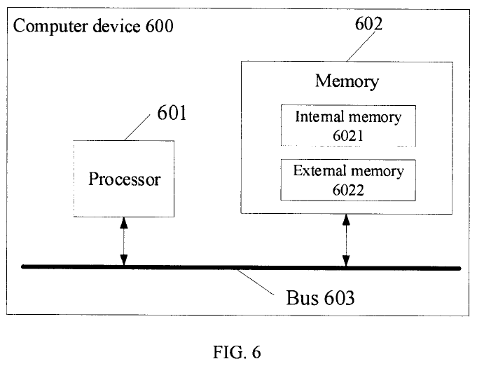

Based on the same technical idea, an embodiment of the present disclosure further provides a computer device. FIG. 6 is a schematic diagram of a computer device according to an embodiment of the present disclosure, the computer device 600 includes a processor 601, a memory 602, and a bus 603. The memory 602 for storing instructions for execution, includes an internal memory 6021 and an external memory 6022; the internal memory 6021 is used for temporarily storing arithmetic data in the processor 601 and data exchanged with the external memory 6022 such as a hard disk, and the processor 601 exchanges data with the external memory 6022 through the internal memory 6021, and when the computer device 600 is operating, the processor 601 communicates with the memory 602 via the bus 603, so that the processor 601 executes the following instructions: displaying a reading content of a target book; in response to a selection operation for at least one content segment in the target book, determining a target video material in a plurality of material dimensions that matches an attribute characteristic of the at least one content segment; generating an authored video associated with the target book based on the target video material and the at least one content segment which is selected.

In an alternative embodiment, the processor 601 executes instructions for determining, in response to the selection operation for the at least one content segment in the target book, the target video material in the plurality of material dimensions that match the attribute characteristic of the at least one content segment, including: in response to the selection operation for the at least one content segment in the target book, displaying, for each of the material dimensions, a plurality of candidate video materials matching the attribute characteristic of the at least one content segment; determining the target video material selected by a user from each of the candidate video materials in the plurality of material dimensions.

In an alternative embodiment, the processor 601 executes instructions for determining, in response to the selection operation for the at least one content segment in the target book, the target video material in the plurality of material dimensions that match the attribute characteristic of the at least one content segment, including: displaying a plurality of published videos that match the attribute characteristic of the at least one content segment in response to the selection operation for the at least one content segment in the target book; determining a reference video selected by a user from the plurality of published videos and extracting the target video material of the reference video at the plurality of material dimensions.

In an alternative embodiment, the processor 601 executes instructions for further integrating the authored video into a video collection corresponding to the target book after generating the authored video associated with the target book. The video collection includes a plurality of authored videos associated with the target book, and the plurality of authored videos is associated with different content segments of the target book.

In an alternative embodiment, the processor 601 executes instructions for integrating the authored video into the video collection corresponding to the target book, which includes: determining a target video topic matching the authored video from video topics respectively corresponding to a plurality of video collections of the target book; integrating the authored video into the video collection corresponding to the target video topic.

In an alternative embodiment, the processor 601 executes instructions for generating the authored video associated with the target book based on the target video material and the at least one content segment which is selected, which includes: adding the content segment to a background picture material in the target video material to obtain a video frame picture; generating the authored video based on at least one selected from the group consisting of a background music material, a transition special effects material, and a dubbing material corresponding to the content segment in the target video material, and the video frame picture.

In an alternative embodiment, after generating the authored video associated with the target book, the processor 601 executes instructions for further displaying a preview identification of the authored video at a preset location in the target book; or displaying a preview identification of the authored video in a recommended video display region associated with the target book; or displaying a preview identification of the authored video in a discussion group associated with the target book.

In an alternative embodiment, after generating the authored video associated with the target book, the processor 601 executes instructions for further displaying a video editing page in response to an editing triggering operation for the authored video, the video editing page including a plurality of editing tools therein; acquiring a target authored video after editing the authored video based on the editing tool.

An embodiment of the present disclosure further provides a computer readable storage medium, a computer program is stored on the computer readable storage medium, and when the computer program is executed by a processor, steps of the video authoring method described in the above method embodiments is performed. The storage medium may be a volatile or non-volatile computer readable storage medium.

The embodiments of the present disclosure further provide a computer program product bearing program code including instructions for executing the steps of the video authoring method described in the above method embodiments, which can be specifically referred to the above method embodiments, which are not described in detail herein.

The above-mentioned computer program product may be specifically implemented by means of hardware, software, or a combination thereof. In one alternative embodiment, the computer program product is embodied as a computer storage medium, and in another alternative embodiment, the computer program product is embodied as a software product, such as a Software Development Kit (SDK) or the like.

It can be clearly understood by those skilled in the art that, for convenience and conciseness of description, the specific working processes of the above-described systems and devices can be referred to the corresponding processes in the foregoing method embodiments, which are not repeated herein. In the several embodiments provided by the present disclosure, it is to be understood that the disclosed systems, devices, and methods may be implemented in other ways. The apparatus embodiments described above are merely illustrative, for example, the division of the units is merely one logical function, and other divisions may be actually implemented, for example, multiple units or components may be combined or integrated into another system, or some features may be omitted or not performed. Further, the coupling or direct coupling or communication connection between each other shown or discussed may be an indirect coupling or communication connection through some communication interface, device or unit, which may be electrical, mechanical or otherwise.

The elements illustrated as separate elements may or may not be physically separate, and the elements shown as elements may or may not be physical elements, i.e. may be located at one place, or may be distributed over a plurality of network elements. Some or all of the elements may be selected according to actual needs to achieve the purpose of the present embodiment.

In addition, each functional unit in each embodiment of the present disclosure may be integrated in one processing unit, each unit may be physically present separately, and two or more units may be integrated in one unit.

The functions, if implemented in the form of a software functional unit and sold or used as a stand-alone product, may be stored in a processor-executable non-volatile computer-readable storage medium. Based on such an understanding, the technical solution of the present disclosure in essence or the part contributing to the prior art or the part of the technical solution may be embodied in the form of a software product, which is stored in a storage medium, and includes a plurality of instructions for causing a computer device (which may be a personal computer, a server, or a network device, etc.) to perform all or a part of the steps of the methods of the various embodiments of the present disclosure. The aforementioned storage media include various media that can store program codes, such as a U disk, a removable hard disk, a Read-Only Memory (ROM), a Random Access Memory (RAM), a magnetic disk, or an optical disk.

Finally, it should be noted that the above-described embodiments are only specific implementation(s) of the present disclosure to illustrate the technical solutions of the present disclosure rather than to limit the scope of the present disclosure, and the scope of protection of the present disclosure is not limited thereto. Although the present disclosure has been described in detail with reference to the foregoing embodiments, those skilled in the art will appreciate that any person skilled in the art may modify the technical solutions described in the foregoing embodiments or may easily conceive of variations, or may substitute equivalents to some of the technical features thereof, within the technical scope of the present disclosure; while these modifications, variations or replacements, which do not make the essence of the corresponding technical solutions depart from the spirit and scope of the technical solutions of the embodiments of the present disclosure, shall be covered within the protection scope of the present disclosure. Therefore, the protection scope of the present disclosure should be subject to the protection scope of the claims.

1. A video authoring method, comprising:
displaying a reading content of a target book;
in response to a selection operation for at least one content segment in the target book, determining a target video material in a plurality of material dimensions that matches an attribute characteristic of the at least one content segment;
generating an authored video associated with the target book based on the target video material and the at least one content segment which is selected.

2. The method according to claim 1, wherein determining the target video material in the plurality of material dimensions that matches the attribute characteristic of the at least one content segment in response to the selection operation for the at least one content segment in the target book comprises:
in response to the selection operation for the at least one content segment in the target book, displaying, for each of the material dimensions, a plurality of candidate video materials matching the attribute characteristic of the at least one content segment;
determining the target video material selected by a user from each of the candidate video materials in the plurality of material dimensions.

3. The method according to claim 1, wherein determining the target video material in the plurality of material dimensions that matches the attribute characteristic of the at least one content segment in response to the selection operation for the at least one content segment in the target book comprises:
displaying a plurality of published videos that matches the attribute characteristic of the at least one content segment in response to the selection operation for the at least one content segment in the target book;
determining a reference video selected by a user from the plurality of published videos and extracting the target video material of the reference video at the plurality of material dimensions.

4. The method according to claim 1, wherein after generating the authored video associated with the target book, the method further comprises:
integrating the authored video into a video collection corresponding to the target book;
wherein the video collection comprises a plurality of authored videos associated with the target book, and the plurality of authored videos is associated with different content segments of the target book.

5. The method according to claim 4, wherein integrating the authored video into the video collection corresponding to the target book comprises:
determining a target video topic matching the authored video from video topics respectively corresponding to a plurality of video collections of the target book;
integrating the authored video into the video collection corresponding to the target video topic.

6. The method according to claim 1, wherein generating the authored video associated with the target book based on the target video material and the at least one content segment which is selected comprises:
adding the content segment to a background picture material in the target video material to obtain a video frame picture;
generating the authored video based on at least one selected from the group consisting of a background music material, a transition special effects material, and a dubbing material corresponding to the content segment in the target video material, and the video frame picture.

7. The method according to claim 1, wherein after generating the authored video associated with the target book, the method further comprises:
displaying a preview identification of the authored video at a preset location in the target book.

8. The method according to claim 1, wherein after generating the authored video associated with the target book, the method further comprises:
displaying a preview identification of the authored video in a recommended video display region associated with the target book.

9. The method according to claim 1, wherein after generating the authored video associated with the target book, the method further comprises:
displaying a preview identification of the authored video in a discussion group associated with the target book.

10. The method according to claim 1, wherein after generating the authored video associated with the target book, the method further comprises:
displaying a video editing page in response to an editing triggering operation for the authored video, the video editing page comprising a plurality of editing tools therein;
acquiring a target authored video after editing the authored video based on the editing tool.

11. A video authoring apparatus, comprising:
a first display module, configured to display a reading content of a target book;
a determination module, configured to determine, in response to a selection operation for at least one content segment in the target book, a target video material in a plurality of material dimensions that matches an attribute characteristic of the at least one content segment;
a generating module, configured to generate an authored video associated with the target book based on the target video material and the at least one content segment which is selected.

12. The video authoring apparatus according to claim 11, further comprising:
an integrating module, configured to integrate the authored video into a video collection corresponding to the target book after generating the authored video associated with the target book.

13. The video authoring apparatus according to claim 11, further comprising:
a second displaying module, after generating the authored video associated with the target book, configured to: display a preview identification of the authored video at a preset location in the target book; or display a preview identification of the authored video in a recommended video display region associated with the target book; or display a preview identification of the authored video in a discussion group associated with the target book.

14. The video authoring apparatus according to claim 11, further comprising:
an editing module, after generating the authored video associated with the target book, configured to display a video editing page in response to an editing triggering operation for the authored video, the video editing page comprising a plurality of editing tools therein; acquire a target authored video after editing the authored video based on the editing tool.

15. A computer device, comprising: a processor, a memory and a bus, the memory storing machine-readable instructions executable by the processor, the processor in communication with the memory via the bus when the computer device is in operation, the machine-readable instructions when executed by the processor perform steps of a video authoring method, the video authoring method comprises:
displaying a reading content of a target book;
in response to a selection operation for at least one content segment in the target book, determining a target video material in a plurality of material dimensions that matches an attribute characteristic of the at least one content segment;
generating an authored video associated with the target book based on the target video material and the at least one content segment which is selected.

16. The computer device according to claim 15, wherein determining the target video material in the plurality of material dimensions that matches the attribute characteristic of the at least one content segment in response to the selection operation for the at least one content segment in the target book comprises:
in response to the selection operation for the at least one content segment in the target book, displaying, for each of the material dimensions, a plurality of candidate video materials matching the attribute characteristic of the at least one content segment;
determining the target video material selected by a user from each of the candidate video materials in the plurality of material dimensions.

17. The computer device according to claim 15, wherein determining the target video material in the plurality of material dimensions that matches the attribute characteristic of the at least one content segment in response to the selection operation for the at least one content segment in the target book comprises:
displaying a plurality of published videos that matches the attribute characteristic of the at least one content segment in response to the selection operation for the at least one content segment in the target book;
determining a reference video selected by a user from the plurality of published videos and extracting the target video material of the reference video at the plurality of material dimensions.

18. The computer device according to claim 15, wherein after generating the authored video associated with the target book, the method further comprises:
integrating the authored video into a video collection corresponding to the target book;
wherein the video collection comprises a plurality of authored videos associated with the target book, and the plurality of authored videos is associated with different content segments of the target book.

19. The computer device according to claim 18, wherein integrating the authored video into the video collection corresponding to the target book comprises:
determining a target video topic matching the authored video from video topics respectively corresponding to a plurality of video collections of the target book;
integrating the authored video into the video collection corresponding to the target video topic.

20. A computer readable storage medium, wherein a computer program is stored on the computer readable storage medium, and when the computer program is executed by a processor, steps of the video authoring method according to claim 1 is performed.
